(19) United States
(12) Patent Application Publication
(10) Pub. No.: US 2001/0049908 A1
(43) Pub. Date: Dec. 13, 2001

(54) Automatic mechanism for wheelchair lift passenger access door

(75) Inventors: Alan R. Cohn, Lockeford, CA (US); Curtis J. Simon, Pine Grove, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lift-U, Division of Hogan Mfg., Inc.

(21) Appl. No.: 09/765,051

(22) Filed: Jan. 16, 2001

Related U.S. Application Data
(60) Provisional application No. 60/176,229, filed on Jan. 14, 2000.

(51) Int. Cl. E05F 11/00

(52) U.S. Cl. 49/360

(57) ABSTRACT

An automatic door reciprocating system (20) is disclosed. The automatic reciprocating system is adapted for use with a wheelchair lift (152) designed to be stowed in a lower compartment of a vehicle (24). The vehicle includes a floor and a sliding door (22) where the sliding door is slidable between open and closed positions. The wheelchair lift includes a platform that is movable between an upper position, where the platform is substantially coplanar with the floor, and a lower position. The automatic door reciprocating system includes a reciprocating assembly (26) for automatically reciprocating the sliding door between the opened and closed positions.

### PRIORITY CLAIM (RELATED APPLICATION)

Priority is claimed under 35 U.S.C. §119(e) from U.S. Provisional Patent Application Ser. No. 60/176,229, filed Jan. 14, 2000, the disclosure of which is hereby expressly incorporated by reference.

### FIELD OF THE INVENTION

The present invention relates generally to wheelchair lifts and, more particularly, to an automatic drive assembly for a wheelchair lift passenger access door.

### BACKGROUND OF THE INVENTION

The Americans With Disabilities Act (ADA) requires the removal of physical obstacles to those who are physically challenged. Consequently, there has been more emphasis in providing access systems to a motor vehicle, such as a tour or inter-city bus. In a typical tour bus, the floor may be located approximately fifty-four inches above the pavement, while the underside of the bus may be approximately thirteen inches above the pavement. Similarly, the floor of a railway car may often times be many feet above the floor of an adjacent platform. Such distances require a lifting mechanism that cannot easily be contained within the space available around the stairwell of such a bus or railway car.

A common manner of providing the physically challenged with access to a tour bus or railway car is a platform-type wheelchair lift of the type disclosed in U.S. Pat. No. 5,111,914, issued to Kempf, the disclosure of which is hereby expressly incorporated by reference. Platform-type wheelchair lifts may be stowed beneath a passenger access door dedicated to providing access into and out of a motor vehicle for the physically challenged. In currently available designs, the passenger access door is manually operated between an open and close position, and is tied to the operation of the platform lift. Although such lifts are highly effective and are a significant improvement over prior lift designs, it has been determined that an automatic mechanism for the access door is desirable for several reasons.

First, with an automatic mechanism, the entire wheelchair platform assembly may be operated from a single convenient location. A related advantage of such a mechanism includes the operation of both the platform lift and the door from one single hand-held control unit. Finally, because the mechanism is automated, there is no manual operation involved and, therefore, such a unit is more operator friendly than current designs.

In view of the foregoing, there is a need for an automatic mechanism for a wheelchair lift passenger access door.

### SUMMARY OF THE INVENTION

In accordance with certain embodiments of the present invention, an automatic door reciprocating system for use with a wheelchair lift is provided. The wheelchair lift is designed to be stowed within a lower compartment of a vehicle having a floor and a sliding door. The sliding door is slidable between open and closed positions. The wheelchair lift includes a platform that is movable between an upper position, where the platform is substantially coplanar with the floor, and a lower position. The automatic door reciprocating system includes a reciprocating assembly for automatically reciprocating the sliding door between the open and closed positions.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of an automatic mechanism formed in accordance with one embodiment of the present invention for a wheelchair access door;

FIG. 2 is a perspective view of a drive assembly of an automatic mechanism for a wheelchair lift passenger access door formed in accordance with one embodiment of the present invention;

FIG. 3 is a perspective view of a plug shaft assembly for an automatic mechanism for a wheelchair lift passenger access door formed in accordance with one embodiment of the present invention;

FIG. 4 is a perspective view of an automatic mechanism for a wheelchair lift passenger access door formed in accordance with one embodiment of the present invention, showing a plug drive assembly and a latch assembly;

FIG. 5 is a planar view of the plug drive assembly and latch assembly of FIG. 4, showing the position of the plug drive assembly and latch assembly when the passenger access door is in a plugged position;

FIG. 6 is a planar view of the plug drive assembly and latch assembly of FIG. 4, showing the plug drive assembly and latch assembly when the passenger access door is in an unplugged position;

FIG. 7 is a perspective view of a manual release mechanism of an automatic mechanism for a wheelchair lift passenger access door formed in accordance with one embodiment of the present invention, showing the manual release mechanism in a release position;

FIG. 8 is an environmental view of an automatic mechanism for a wheelchair lift passenger access door, showing the door in the plugged position and the platform lift located a predetermined distance from the passenger access door;

FIG. 9 is an environmental view of an automatic mechanism for a wheelchair lift passenger access door formed in accordance with one embodiment of the present invention, showing the access door in an unplugged position;

FIG. 10 is an environmental view of an automatic mechanism for a wheelchair lift passenger access door formed in accordance with one embodiment of the present invention, showing the access door in the fully open position with the platform lift extending partially into the vehicle;

FIG. 11 is a logic diagram for operation of an automatic mechanism for a wheelchair lift passenger access door formed in accordance with one embodiment of the present invention, illustrating the logic to open the access door;

FIG. 12 is a logic diagram for an automatic mechanism for a wheelchair lift passenger access door formed in accordance with one embodiment of the present invention, illustrating the logic to close the access door;

FIG. 13 is an electrical circuit diagram of an automatic mechanism for a wheelchair lift passenger access door; and

FIG. 14 is a planar view of a plug drive assembly and a latch assembly formed in accordance with an alternate embodiment of the present invention.

### DETAILED DESCRIPTION OF THE PREFERRED EMBODIMENT

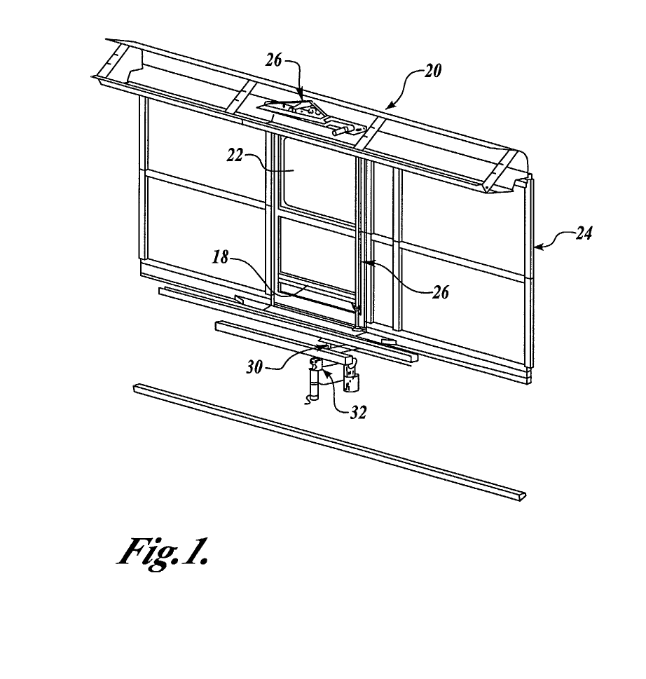

FIG. 1 illustrates an automatic door drive assembly 20 constructed in accordance with one embodiment of the present invention. The door drive assembly 20 is designed to be coupled within a passageway for a wheelchair access door 22 of a vehicle 24, such as a tour bus or railway car. For ease of illustration, only a portion of the vehicle 24 is illustrated.

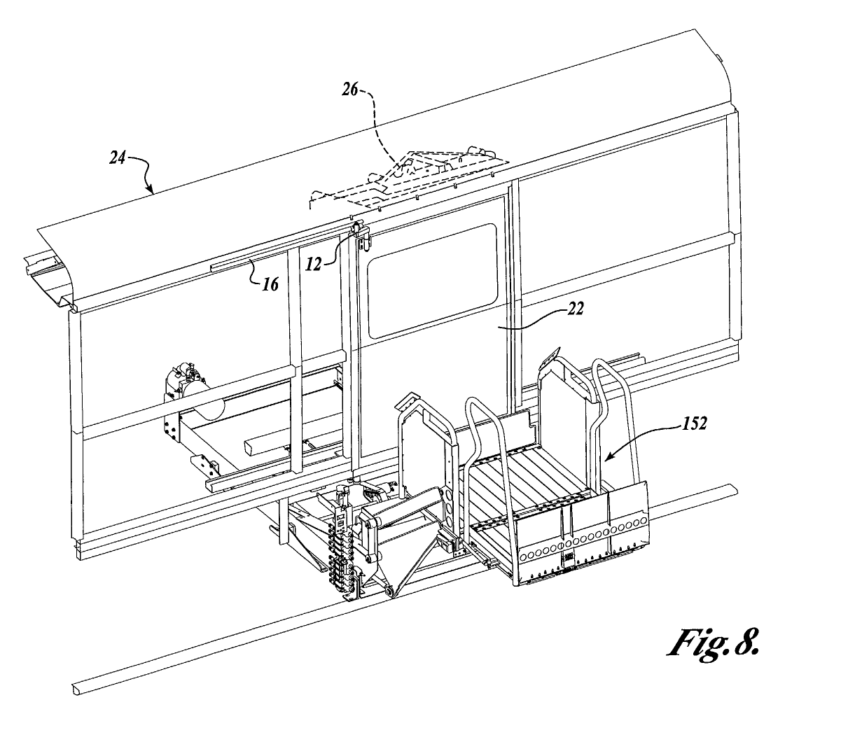

The access door 22 is suitably a sliding door, mounted to the vehicle 24 by a front hanger 10 and a rear hanger 12 (FIG. 8). The front hanger 10 is mounted within a first track 14 located inside the vehicle 24. Similarly, the rear hanger 12 is mounted in a second track 16 located on the outside of the vehicle 24. The front hanger 10 is rigidly mounted to the access door 22, on the inside of the access door 22 near the forward and top edges of the access door 22. The rear hanger 12 is pivotally mounted to the access door 22, on the outside of the access door 22 near the rear and top edges of the access door 22. A door guide rail 18 is rigidly mounted on the inside face of the access door 22 and is arranged to guide the motion of the access door 22, as is well known in the art.

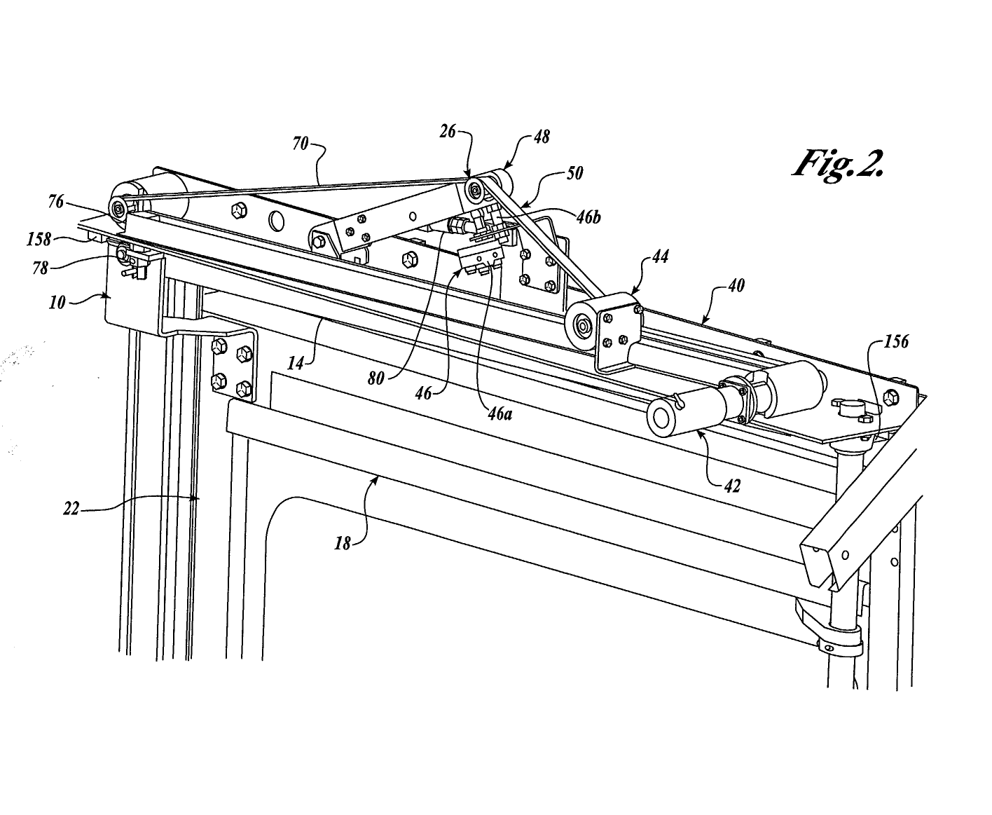

The door drive assembly 20 includes a drive assembly 26, a plug shaft assembly 28, a latch assembly 30, a plug drive assembly 32, and a belt assembly 34. As seen best by referring to FIG. 2, the drive assembly 26 is suitably mounted near the top of the access door 22 by a main frame weldment 40. The drive assembly 26 includes a driver assembly 42, a driven idler assembly 44, an overload switch assembly 46, an idler assembly 48, and a belt assembly 50. The driver assembly includes a well known electric gear motor 60 coupled to a pulley (not shown). In turn, the pulley drives the belt assembly 50.

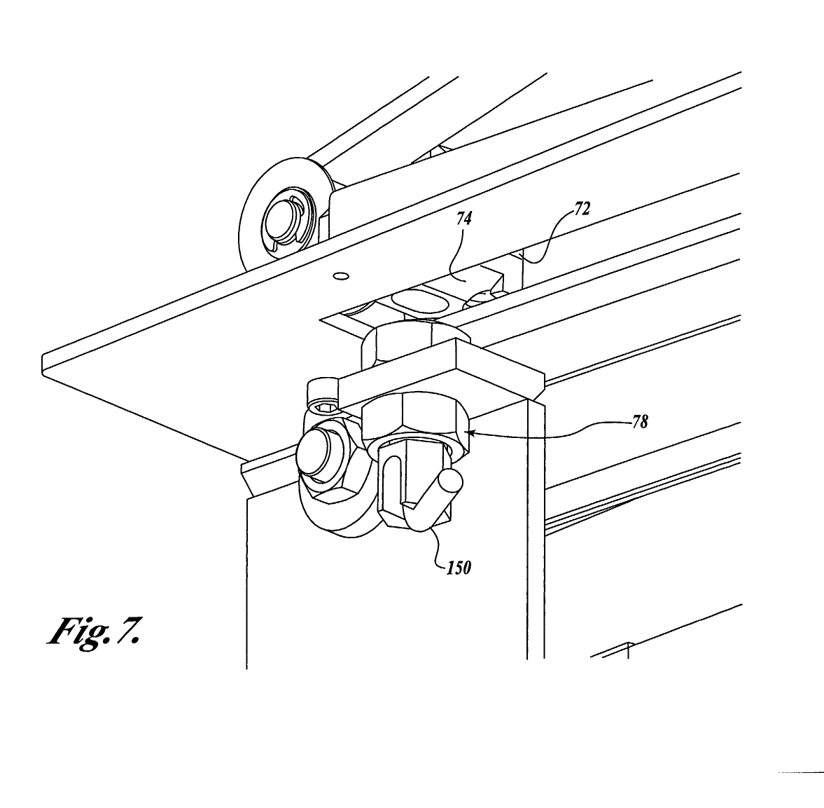

The belt assembly 50 includes a toothed timing belt 70 and upper and lower belt clamps 72 and 74 (FIG. 7). The upper and lower belt clamps 72 and 74 clamp the timing belt 70 and slide in a track 76. The belt assembly 50 also includes a spring-loaded manual release dog 78 located at one end of the track 76. As attached, the belt 70 moves in a circuit, such that the release dog 78 and front hanger 10 and door assembly 22 follow.

The belt circuit is designed to provide a predetermined amount of belt tension when the access door 22 is actuated into the open direction. When the access door 22 is actuated in the closed direction, the tension in the belt assembly 50 is limited by a spring tension assembly 80.

The spring tension assembly 80 is coupled to the idler assembly 48 in a well known manner to limit the tension in the belt assembly 50 as the access door 22 is actuated into the closed position. As the access door 22 is actuated into the closed position and if the access door 22 is obstructed from moving in the closed direction, the tension in the belt 70 increases. As the tension in the belt 70 exceeds a pre-set amount and the idler assembly 48 is displaced downwards into switching contact with the overload switch assembly 46, a signal is transmitted to the door controller (not shown), thereby indicating an overload condition.

The overload switch assembly 46 includes a bias spring stop 46b and a switch mechanism 46a, such as a micro limit switch. The stop 46b is located near the overload switch assembly 46 and is adapted to limit travel of the idler assembly 48, such that the belt 70 will not slip. Having received an overload signal, the door controller reverses the direction of access door 22 toward the full open position. Although the overload switch assembly 46 is preferably a micro-limit switch, other types of switches or sensors, such as a proximity sensor, are also within the scope of the present invention.

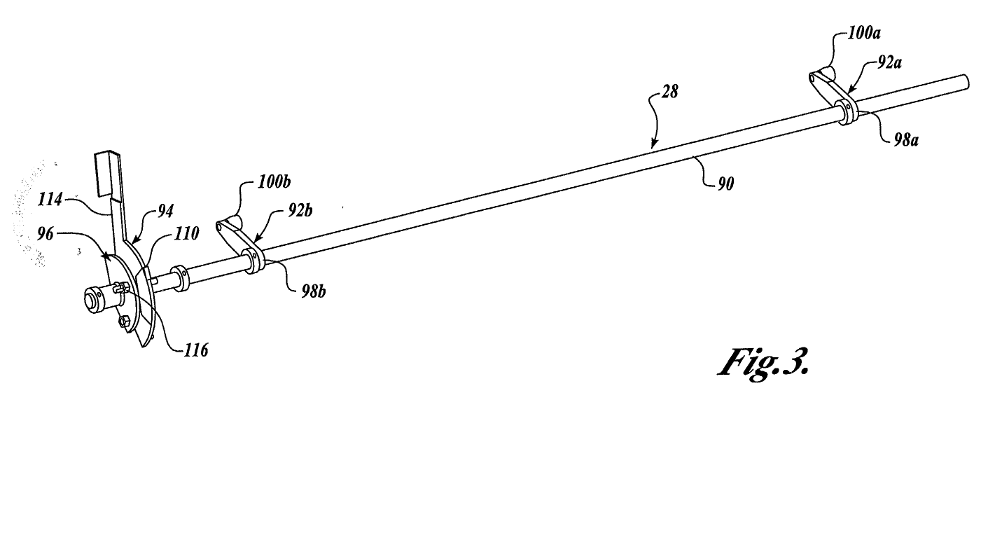

Referring now to FIG. 3, the plugged shaft assembly 28 will now be described in greater detail. The plug shaft assembly 28 includes a shaft 90, first and second arm weldments 92a and 92b, a plug drive handle assembly 94, and a plug drive plate assembly 96. Preferably, the shaft 90 is hollow to allow electrical cables to pass from a location within the vehicle 24, such as a baggage compartment, where the lift and door controllers are located, to the location of the drive assembly 26. Although a hollow shaft 90 is preferred, other types of shafts, such as a solid shaft, are also within the scope of the present invention.

Each arm weldment 92a and 92b includes a shaft arm 98a and 98b and a roller 100a and 100b. One end of the shaft arm 98a and 98b is fixed to the shafts 90. One of the first and second rollers 100a and 100b is disposed at the other end of each shaft arm 98a and 98b. The rollers 100a and 100b roll in the guide door rails 18 located on the access door 22.

The plug drive handle assembly 94 is fixed to one end of the shaft 90 and includes a latch detent 110, a bias spring 112, and a manual operation handle 114. The plug drive handle assembly 94 also includes a manual release dog 116. The manual release dog 116 fits within a hole 114a located in the manual operation handle 114. The dog 116 is of similar construction and operation as the dog 78.

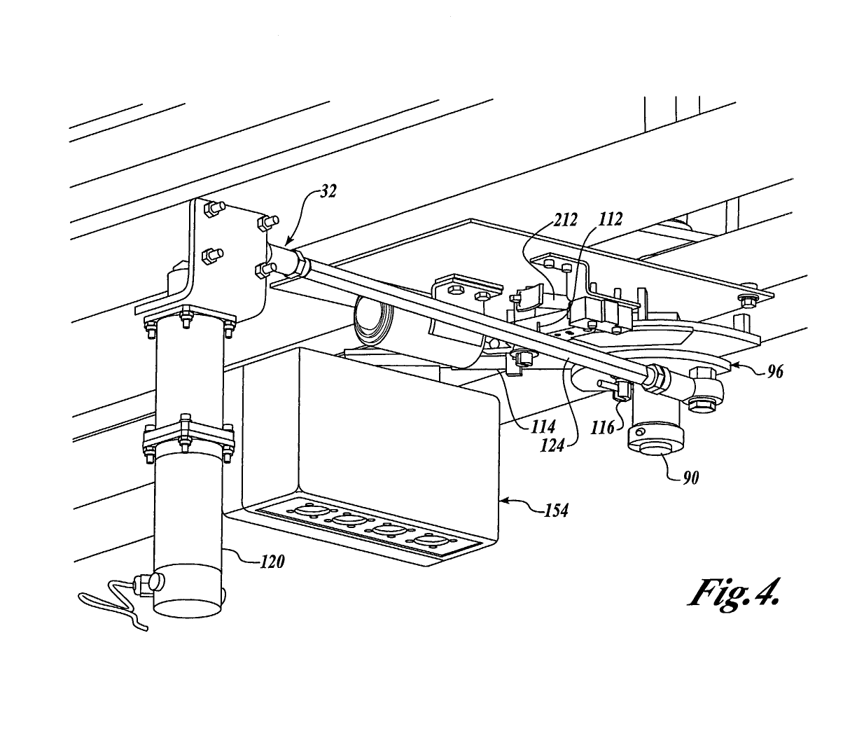

Referring to FIG. 4, the plug drive plate assembly 96 is pivotally mounted on the shaft 90 and is connected to the manual operation handle 114 by the manual release dog 116. The plug drive plate assembly 96 is also connected to the plug drive assembly 32.

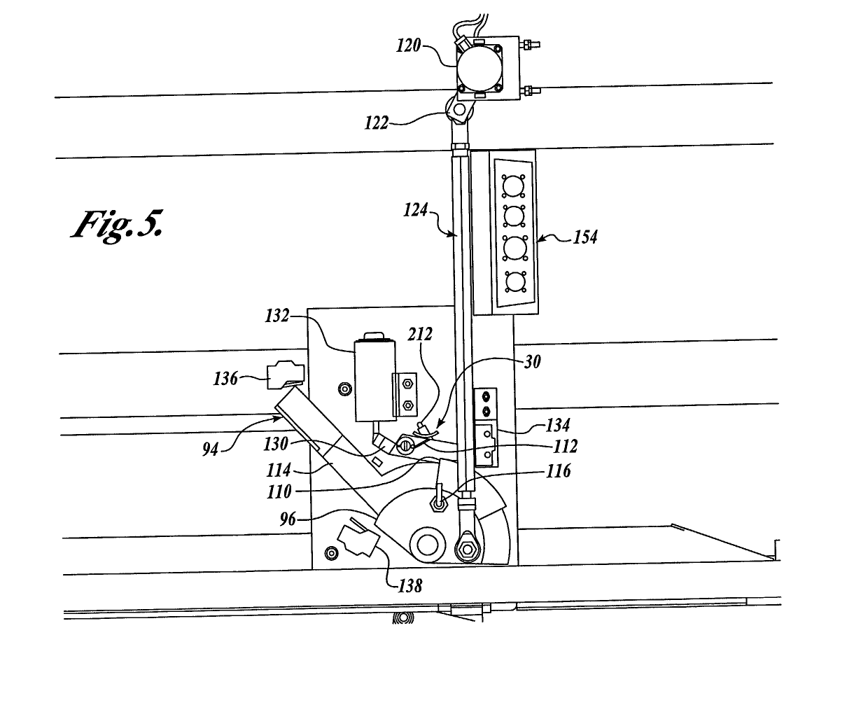

Referring to FIGS. 4 and 5, the plug drive assembly 32 will now be described in greater detail. The plug drive assembly 32 includes a drive motor 120, a master arm 122, and a push rod assembly 124. One end of the push rod assembly 124 is pinned to one end of the master arm 122. The other end of the master arm 122 is similarly pinned to the drive motor 120. The other end of the push rod assembly 124 is pinned to the plug drive plate assembly 96.

The drive motor 120 acts as a rotary actuator and transmits force through the push rod assembly 124 to drive the plug shaft assembly 28. As noted above, the push rod assembly 124 is pinned to the plug drive plate assembly 96. As a result, motion of the plug shaft assembly 28 is driven by actuation of the plug drive assembly 32. The plug shaft assembly 28 travels through an angle of approximately 45 degrees when the door is actuated between a plugged and an unplugged position, as is described in greater detail below.

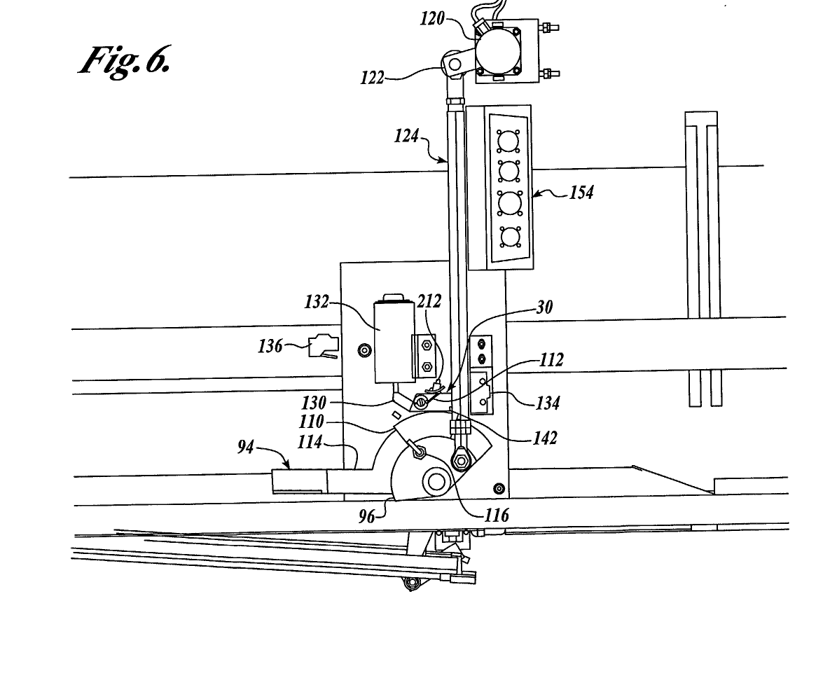

Referring now to FIGS. 5 and 6, the latch plate assembly 30 will be described in greater detail. The latch plate assembly 30 includes a latch arm 130, a solenoid 132, a latch sensor 134, a plugged sensor 136, and an unplugged sensor 138. The latch arm 130 extends between the solenoid 132 and the latch sensor 134.

The latch arm 130 includes a notch 142 sized to lockingly receive the latch detent 110 of the plug drive handle assembly 94. The spring loaded latch arm 130 catches the latch detent 110 of the plug drive handle assembly 94, thereby holding the access door 22 in a closed and locked position. In this position, the latch sensor 134 indicates that the latch arm 130 is in the latched position.

As seen best by referring to FIG. 5, in the latched position, the free end of the manual operation handle 114 is displaced against the plugged sensor 136, thereby indicating that the door assembly 22 is in the plugged position.

As seen best by referring to FIG. 6, the latch plate assembly 30 may be selectively actuated into the unplugged position by the plug drive assembly 32. In this position, the drive motor 120 pulls the push rod assembly 124 to rotate the manual operation handle 114 into a position relative to the unplugged sensor 138 indicative that the access door 22 is unplugged. In this position, the solenoid 132 releases the latch arm 130, and the latch arm 130 is no longer in contact with the latch sensor 134. After the latch arm 130 is released, the access door 22 may be unplugged. Although the current embodiment of the present invention describes the latch, plugged and unplugged as sensors, other devices, such as switches, are also within the scope of the present invention.

It should be apparent that the access door 22 can be actuated by a variety of different methods, including electric, as described above, hydraulic, pneumatic, by motors or cylinders, and with or without belts. Further, a manual override is possible by releasing the manual release dog 78. As best seen by referring to FIG. 7, the manual release dog 78 may be spring loaded and transmits a force from the upper and lower belt clamps 72 and 74 to the front hanger 10. In the event of a power failure, the manual release dog 78 may be decoupled from the lower belt clamp 74 by pulling an “L” shape lever pin 150 downwardly within the manual release dog and rotating the lever pin 150, such that the base portion of the pin 150 is selectively locked against the lower edge of the manual release dog 78.

When the lever pin 150 is displaced into the unlocked position, the other end of the lever pin 150 is removed from within the lower belt clamp 74, thereby allowing the access door 22 to be manually plugged and unplugged, as well as reciprocated between the open and closed positions. Further, the door open and close driving motion, and/or the plugging and unplugging drive motion may be back driven in the event of power failure, without releasing the manual dog 78. Also, during manual operation, a bias spring 212 urges the manual operation handle 114 toward either plugged or unplugged positions in a toggle like manner.

Operation of the door drive assembly 20 may be best understood by referring to FIGS. 8-10. To clarify operation of the current embodiment of the present invention, a well known platform lift 152, such as that disclosed in U.S. Pat. No. 5,158,419, issued to Kempf et al., the disclosure of which is hereby expressly incorporated by reference, is illustrated. The ramp platform 152 may be reciprocated between stowed and deployed positions, such that it may be selectively positioned adjacent the access door 22 to load and unload passengers from the lift 152.

When approaching the access door 22 of a vehicle 24, the lift 152 stops a predetermined distance of reaching the access door 22 and sends a signal to open the access door 22 to a well-known door controller 154. The door controller 154 having received an open signal, unlatches the access door 22. The access door 22 is unplugged, using the drive assembly 26 as described above.

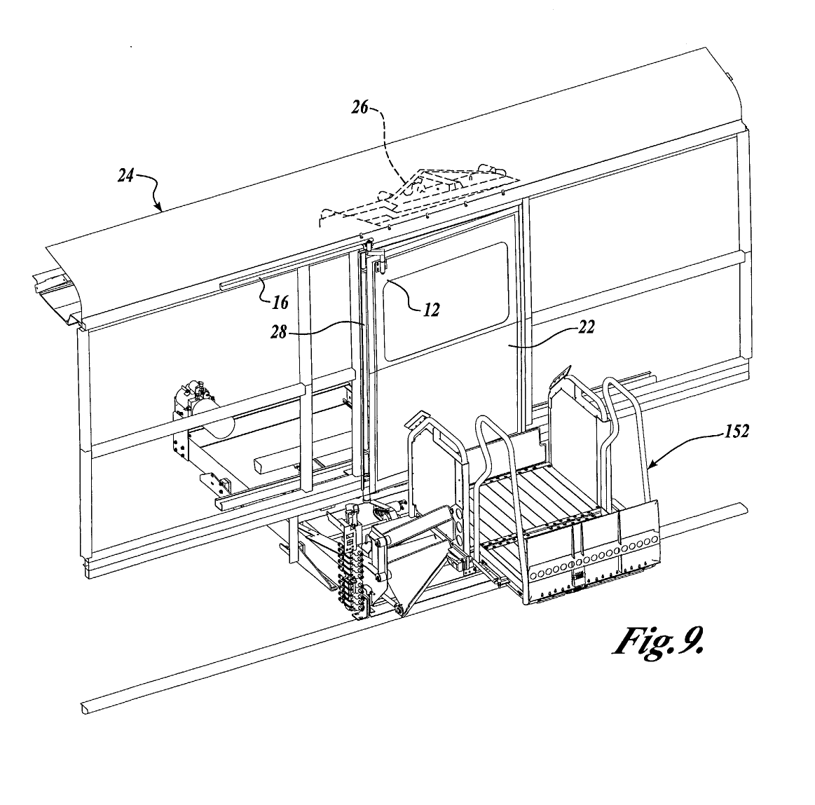

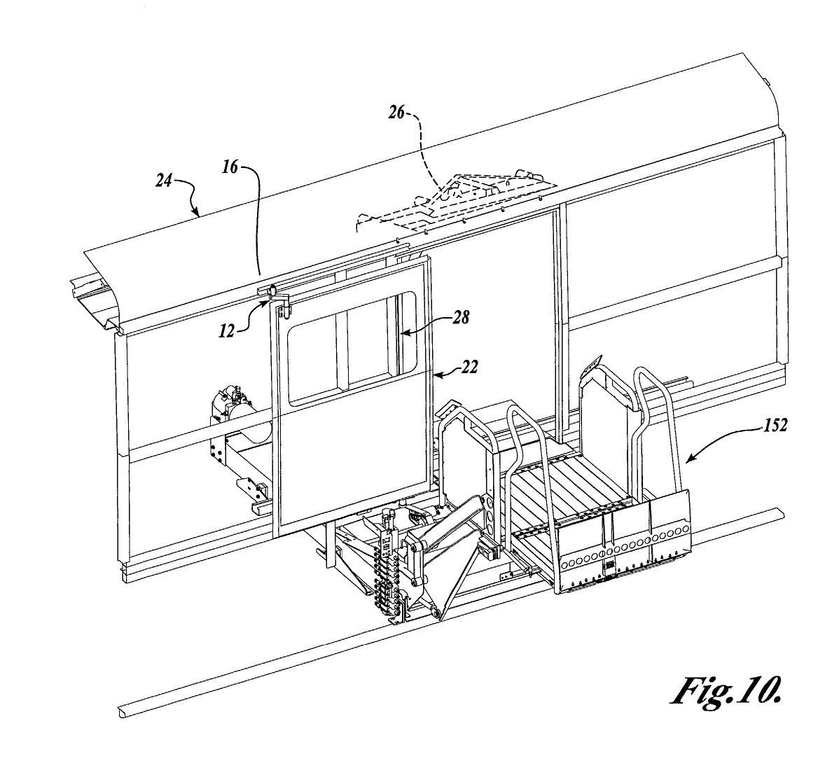

As seen best by referring to FIG. 9, one edge of the door assembly 22 is displaced outwardly away from the vehicle 24. In this position, the unplugged sensor 138 indicates a door unplugged position to the door controller 154. The access door 22 is then opened by the drive assembly 26, as also described above. When the access door 22 is in the fully open position, a portion of the access door 22 comes into contact with a door open sensor 156 (FIG. 2), thereby indicating to the door controller 154 that the access door 22 is open. The door controller 154 then sends a signal to the lift controller (not shown) that the access door 22 is open. The lift 152 then proceeds to the vehicle floor and docks with the vehicle floor, as seen in FIG. 10.

The door controller 154 works in reverse as described to close the access door 22. To close the access door 22, the lift 152 undocks from the vehicle floor and moves away from the door opening a predetermined distance and stops. The lift controller sends a signal to the door controller 154 to close the door. Using the drive assembly 26, the door controller 154 closes the access door 22 until a close door sensor 158 (FIG. 2) indicates that the access door 22 is closed. The access door 22 is then plugged and latched using the drive assembly 26, as described above. The door controller 154 then sends a signal that the access door 22 is latched. The lift controller then resumes control of the lift 152 to a lower or stowed position.

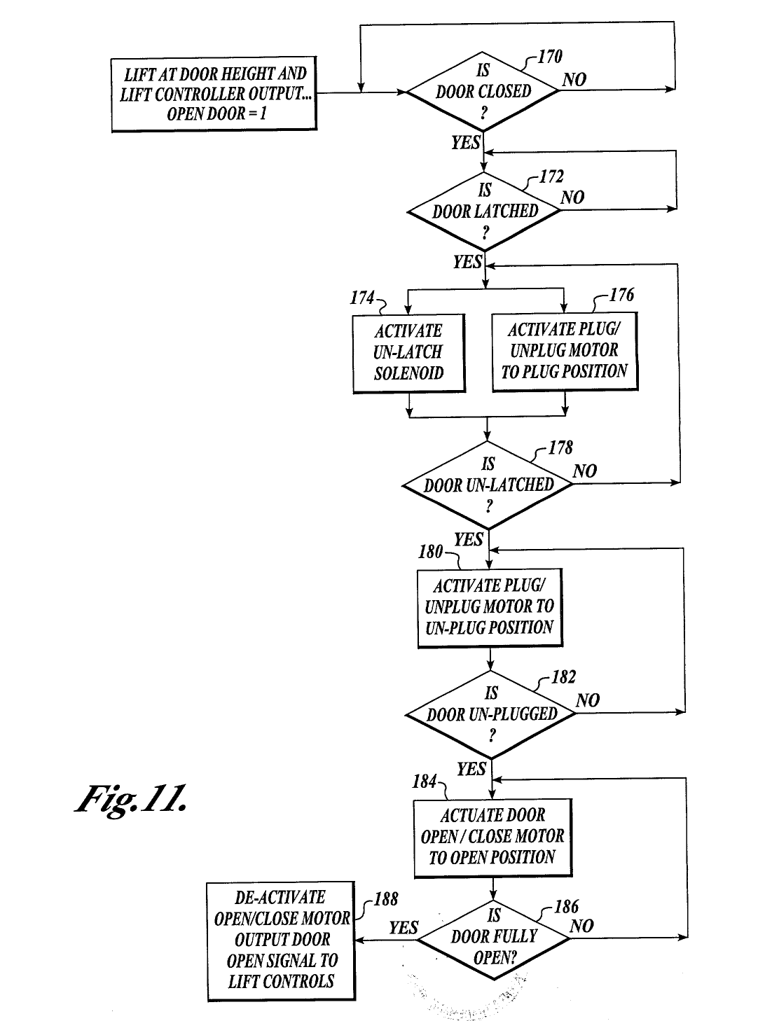

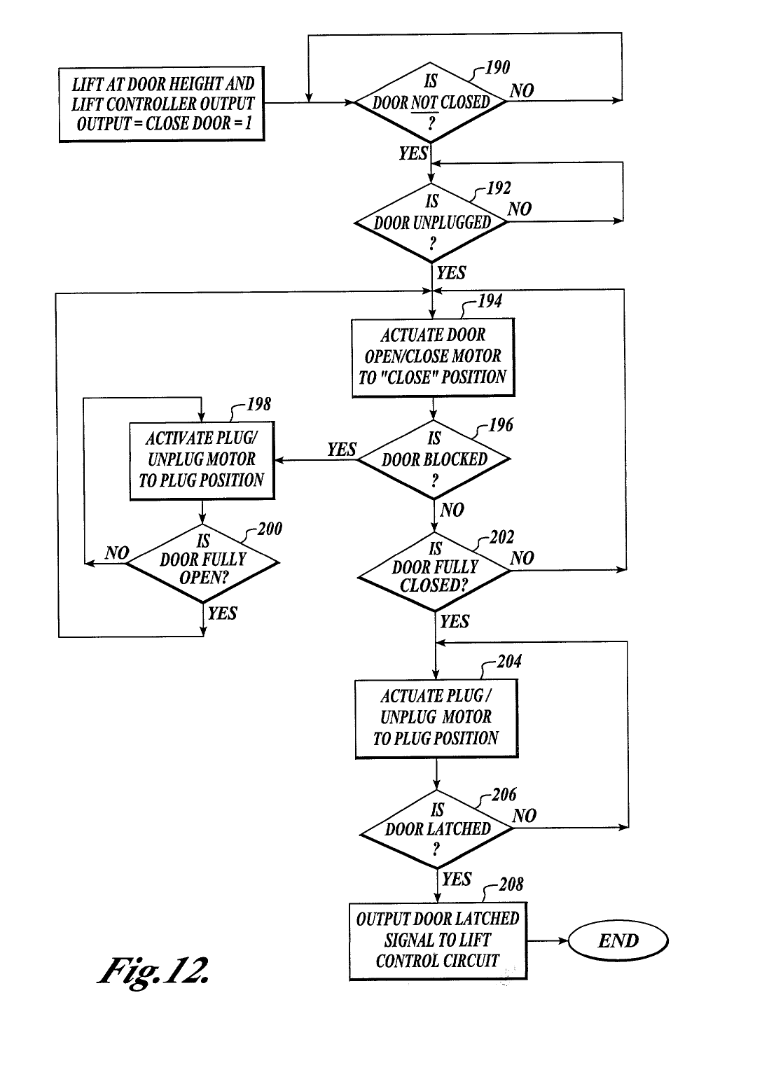

Operation of the door drive assembly 20 may be further understood by referring to FIGS. 11 and 12. In FIG. 11, the platform of the lift 152 is assumed to be at the height of the floor for the vehicle 24 and the door controller 154 is actuated into the open door position. In this position, a single is sent to a door control circuit (DCC) from the lift control circuit. The DCC reads the closed door sensor 158 and determines whether the access door 22 is closed, as indicated by the decision block 170. In the event that the DCC has an indication that all signals are high, typically recognized as positive voltage, the circuits will then actuate the drive motor 120 in connection with the solenoid 132 of the latch plate assembly 30. The purpose of this dual action is to remove excess friction of the latch mechanism and allow for an easier unlatching action by the solenoid 132, and generally indicated by the block 174.

The circuit then determines whether the latch arm 130 is in the unlatched position, as indicated by the decision block 178. If the circuit indicates that the latch arm 130 is in an unlatched position, it then reverses power to the drive motor 120, as indicated by the block 180. This causes the access door 22 to pull away from its plugged and latched position.

When the access door 22 has reached a full unplugged position (FIG. 9), the unplugged sensor 138 is actuated and gives the circuit a signal. The circuit verifies that the access door 22 is unplugged, as indicated by the decision block 182. This signal, in conjunction with an unlatched indication and an open door signal, passes through a set of relay contacts and then to a field effect transistor (FET), commonly referred to as a source driver. This source driver actuates a high current relay which actuates the electric gear motor 60 in the open direction, as generally indicated by the block 184. The use of the relay in this manner not only allows for a higher current source, but also allows the use of a separate voltage source and provides for isolation from the controlling circuit voltage. A further advantage of such a circuitry is to provide for a ground potential on both sides of the motor 60 to minimize arcing on activation of the relay contacts.

When the access door 22 has reached a full open position, as generally indicated by the decision block 186, the door open sensor 156 is activated and sends a signal to the DCC. This signal terminates the logic action that causes the motor 60 to operate in the open direction. At this point, the DCC also sends a signal to the lift control circuit that a raise function can now be continued, as generally indicated by the block 188.

With reference to FIG. 12, actuation of the access door 22 to the closed position will now be described in greater detail. For purposes of FIG. 12, the platform of the lift 152 is assumed to be undocked from the floor level of the vehicle 24 and the lift controller output indicates that the access door 22 is to be actuated into the closed position. In this position, a signal is sent to the DCC from the lift control circuitry. This signal, in conjunction with a not closed signal, generally indicated by the decision block 190, and a signal that the access door 22 is unplugged, as generally indicated by the decision block 192, will activate the electric motor 60 to the closed position, generally indicated by the block 194. This causes the access door 22 to commence closing and move away from the door open switch 156. The loss of the door open signal is conditioned by the logic in the DCC and is applied as a reset signal to the relay.

During the close mode, if an obstacle should impede the closing motion, as generally indicated by the decision block 196, the overload switch 46a is activated, thereby sending a signal to the DCC. This signal causes the relay to set. This set action redirects the close signal to cause the electric gear motor 60 to reverse direction to open, as generally indicated by the block 198. If this action is allowed to continue, the access door 22 will reach a full open position, as generally indicated by the decision block 200, and activate the door open switch 156, which, in turn, sends a signal to the DCC which resets the relay and reverses the access door 22 direction to cause a closing action. If the obstruction is not removed, this action will repeat itself until the door closed command is terminated. The operator can, alternately, deselect “lower” from the lift controller. This action also resets the DCC after an obstruction has been detected. After the obstruction has been removed, and the “lift lower” is selected, the access door 22 will move towards the closed position.

When the access door 22 reaches the closed position, the door close sensor 158 sends a signal to the DCC, as generally indicated by the decision block 202. This signal, in conjunction with the close door command and the unplugged signal, will cause the drive motor 120 of the plug drive assembly 32 to actuate in the plug direction, as generally indicated by the block 204. When the access door 22 reaches the plugged position, the latch sensor 134 sends a signal to the DCC that causes the signal to the drive motor 120 to be removed, as generally indicated by the decision block 206. With the access door 22 in the plugged position, the latch mechanism causes this same signal to be sent to the lift control circuitry, as generally indicated by the block 208, thereby allowing for normal lift operation to continue.

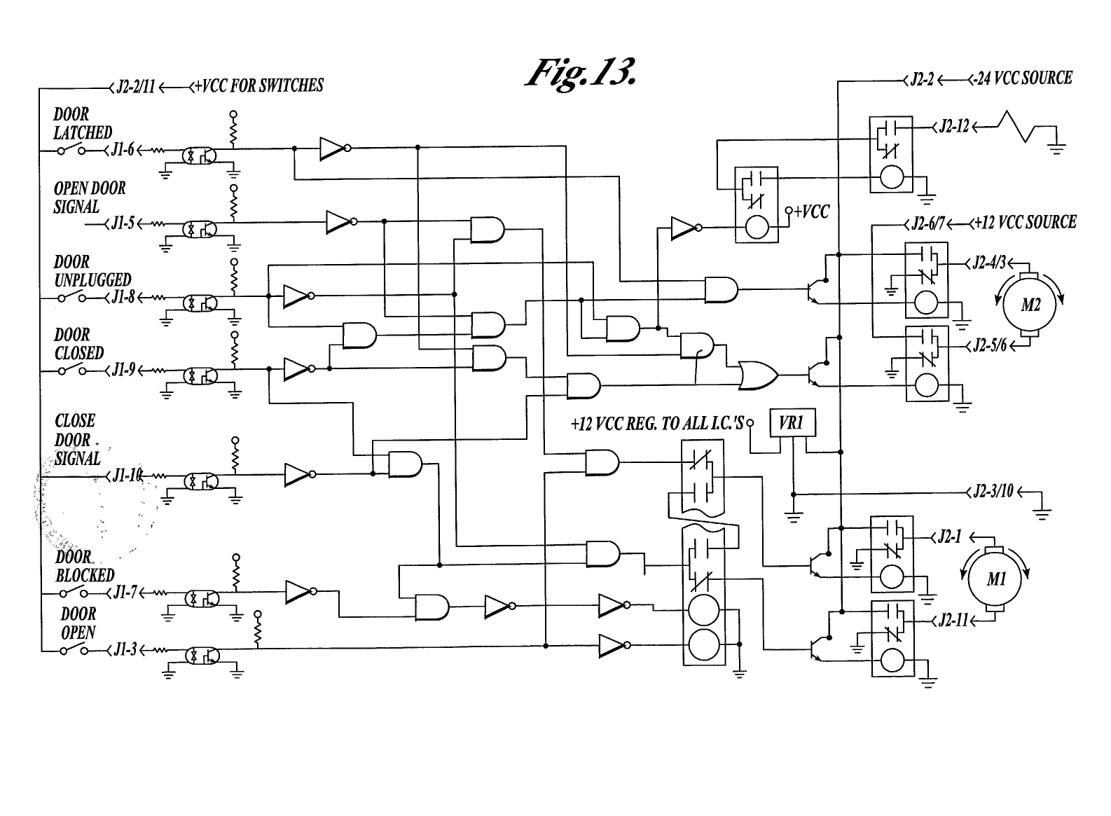

An exemplary circuit used in the above embodiment of the door drive assembly is illustrated in FIG. 13.

While the preferred embodiment of the invention has been illustrated and described, it will be appreciated that various changes can be made therein without departing from the spirit and scope of the invention. As a non-limiting and referring FIG. 14, the push rod assembly 124 may be driven over center to provide additional mechanical latching.

The embodiments of the invention in which an exclusive property or privilege is claimed are defined as follows:

1. An automatic door reciprocating system for use with a wheelchair lift designed to be stowed in a lower compartment of a vehicle, the vehicle having a floor and a sliding door, the sliding door being slidable between open and closed positions, the wheelchair lift having a platform which is movable between an upper position, where the platform is substantially coplanar with the floor, and a lower position, the automatic door reciprocating system comprising:
a reciprocating assembly for automatically reciprocating the sliding door between the open and closed positions.
